(19) United States
(12) Patent Application Publication
(10) Pub. No.: US 2025/0285197 A1
(43) Pub. Date: Sep. 11, 2025

(54) METHOD, SYSTEM, NON-TRANSITORY COMPUTER-READABLE STORAGE MEDIUM, COMPUTER PROGRAM PRODUCT, AND DEVICE FOR ASSISTING USERS IN PLANT CULTIVATION

(71) Applicant: Hangzhou Ruisheng Software Co., Ltd., Zhejiang (CN)

(72) Inventors: Huan Luo, Zhejiang (CN); Mingquan Chen, Zhejiang (CN); Tao He, Zhejiang (CN)

(73) Assignee: Hangzhou Ruisheng Software Co., Ltd., Zhejiang (CN)

(21) Appl. No.: 19/216,622

(22) Filed: May 22, 2025

Related U.S. Application Data
(63) Continuation-in-part of application No. PCT/CN2023/133127, filed on Nov. 22, 2023.

(30) Foreign Application Priority Data
Nov. 29, 2022 (CN) 202211508725.2

(51) Int. Cl. G06Q 50/02; A01D 34/00; A01D 101/00; A01G 3/02; A01G 3/04; G06Q 10/0631

(52) U.S. Cl. CPC G06Q 50/02; A01D 34/006; A01G 3/02; A01G 3/04; G06Q 10/06316; A01D 2101/00

(57) ABSTRACT

The present disclosure provides a method for assisting users in plant cultivation, including: determining a pruning plan according to a plant species and a pruning goal, and determining whether to display the pruning plan to the user according to the current season and/or the plant growth stage, wherein the pruning plan includes a pruning approach and a pruning position; and in response to determining to display the pruning plan to the user, depicting the pruning approach and the pruning position in combination with the image of the plant to display the pruning plan to the user. The present disclosure also relates to a device for assisting users in plant cultivation and a non-transitory computer-readable storage medium.

### CROSS-REFERENCE TO RELATED APPLICATION

This application is a continuation-in-part of application of PCT application serial no. PCT/CN2023/133127 filed on Nov. 22, 2023, which claims the priority benefit of China application no. 202211508725.2 filed on Nov. 29, 2022. The entirety of each of the above-mentioned patent applications is hereby incorporated by reference herein and made a part of this specification.

### BACKGROUND

### Technical Field

The present disclosure relates to the field of computer technology, particularly to a method, device, system for assisting users in plant cultivation and a non-transitory computer-readable storage medium.

### Description of Related Art

Many people enjoy growing plants in their workplaces or living spaces, as plants not only serve to aesthetically enhance the environment and regulate mood; they also function to purify indoor air, thereby contributing to human health and well-being.

In order to facilitate the healthy growth of plants, it is required to provide proper cultivation and care. During the cultivation process, it is often necessary to consult various reference materials to ascertain the appropriate methods of plant care and cultivation.

### SUMMARY

One of the purposes of one or more embodiments of the present disclosure is to provide a method and a device for assisting users in plant cultivation and a non-transitory computer-readable storage medium.

According to a first aspect of an embodiment of the present disclosure, a method for assisting users in plant cultivation is provided, including: determining a pruning plan according to a plant species and a pruning goal, and determining whether to display the pruning plan to the user according to a current season and/or a plant growth stage, wherein the pruning plan includes a pruning approach and a pruning position; and in response to determining to display the pruning plan to the user, depicting the pruning approach and the pruning position in combination with the image of the plant to display the pruning plan to the user.

In some embodiments, the pruning goal includes one or more of maintaining aesthetics, maintaining health, treating pests and diseases, facilitating flowering, and facilitating fruiting.

In some embodiments, the pruning approach includes one or more of a pruning tool, a pruning method, and a pruning degree, wherein, the pruning tool includes one or more of non-gardening scissors, pruning shears, hedge shears, a pruning saw, and a lawn mower. The pruning method includes one or more of pruning broken branches, pruning dead branches, pruning weak branches, pruning diseased branches, pruning tillering branches, pruning drooping branches, pruning parallel branches, pruning crossing branches, pruning retrograde branches, pruning withered flowers, pruning new branches, pruning old branches, pinching, fruit thinning, and bud thinning. The pruning degree indicates the amount to be pruned.

In some embodiments, the method further includes: before determining whether to display the pruning plan to the user according to the current season and/or the plant growth stage, determining the current season according to time information, geographical location information, and climate information.

In some embodiments, the plant growth stage includes a growth period, a dormant period, a flowering period, and a fruiting period.

In some embodiments, the method further includes determining the pruning plan according to the plant species, the pruning goal, and other factors, wherein, the other factors include one or more of a plant health status, a plant growth speed, plant growth years, plant ecological features, plant ornamental properties, a plant growth space, a plant size, a plant age, plant morphological features, and user factors. The plant growth years include annual and perennial varieties. The plant ecological features include one or more of evergreen plants, deciduous plants, flowering plants, non-flowering plants, fruit plants, and non-fruit plants, wherein, flowering plants include new branch/old branch flowering, and fruit plants include new branch/old branch fruiting. The plant ornamental properties include flowering/non-flowering properties. The plant growth space includes indoor space and outdoor space. The plant morphological features include one or more of single head/multiple heads, broken branches, dead branches, weak branches, diseased branches, tillering branches, drooping branches, parallel branches, crossing branches, and retrograde branches.

In some embodiments, the method further includes, before determining the pruning plan according to the plant species and the pruning goal, directly obtaining the plant species from the user through a human-computer interaction approach; and/or obtaining the plant species from the image provided by the user through a computer vision technology.

In some embodiments, in the situation where the plant species is obtained from the image provided by the user through at least the computer vision technology, depicting the pruning position in combination with the image of the plant includes marking the pruning position on the image provided by the user.

In some embodiments, determining the pruning plan according to the plant species and the pruning goal includes: utilizing a pre-trained pruning recognition model to determine the pruning plan according to the plant species and the pruning goal.

In some embodiments, the pruning plan further includes one or more of pruning precautions, pruning principles, pruning theories, and pruning effects, wherein, the pruning principles include hard pruning and light pruning.

According to the second aspect of the embodiments of the present disclosure, a method for assisting users in plant cultivation is provided, including: determining a pruning plan according to a plant species and a plant growth stage. The pruning plan includes a description of the pruning approach and a pruning time, as well as marking of the pruning position. The pruning time includes a pruning season; and in response to the current time matching the pruning time, the pruning plan is displayed to the user.

In some embodiments, the pruning plan is determined according to the plant species, the plant growth stage and other factors. The other factors include one or more of a pruning goal, a plant health status, a plant growth speed, plant growth years, plant ecological features, plant ornamental properties, a plant growth space, a plant size, a plant age, plant morphological features and user factors. The pruning goal includes one or more of maintaining aesthetics, maintaining health, treating pests and diseases, facilitating flowering and facilitating fruiting. The plant growth years include annual and perennial varieties. The plant ecological features include one or more of evergreen plants, deciduous plants, flowering plants, non-flowering plants, fruit plants and non-fruit plants. The flowering plant includes new branch/old branch flowering, and the fruit plant includes new branch/old branch fruiting. The plant ornamental properties include flowering/non-flowering properties. The plant growth space includes indoor space and outdoor space. The plant morphological features include one or more of single head/multiple heads, broken branch, dead branch, weak branch, diseased branch, tillering branch, drooping branch, parallel branch, crossing branch and retrograde branch.

According to the third aspect of the embodiments of the present disclosure, a method for assisting users in plant cultivation is provided, including: determining multiple pruning topics according to a plant species, a current season, a plant growth stage and a pruning goal; displaying the multiple pruning topics to the user; in response to the user's selection operation on the multiple pruning topics, determining a pruning plan related to the pruning topic selected by the user; and displaying the pruning plan to the user.

According to the fourth aspect of the embodiments of the present disclosure, a method for assisting users in plant cultivation is provided, including: providing a cultivation details page for specific plant species, the cultivation details page includes operable items related to the plant pruning goals, the pruning goals include one or more of maintaining aesthetics, maintaining health, treating pests and diseases, facilitating flowering and facilitating fruiting; and in response to the operable items related to plant pruning goals being operated, displaying a pruning plan corresponding to the selected pruning goal to the user in combination with the plant image of the specific plant species, wherein, the pruning plan is determined at least based on the specific plant species and the selected pruning goal.

In some embodiments, the method further includes: in response to the selected pruning goal including maintaining aesthetics, multiple pruning topics are provided; in response to at least one pruning topic among the multiple pruning topics being selected, a pruning plan corresponding to the selected pruning topic is displayed to the user.

In some embodiments, under the corresponding pruning goal, the pruning plan includes the pruning time, pruning position, pruning tool, pruning method and pruning degree of the specific plant species.

In some embodiments, the specific plant species is specified by the user.

According to the fifth aspect of the embodiments of the present disclosure, a method for assisting users in plant cultivation is provided, including: recognizing the plant properties and the plant status according to one or more images of the plant; determining whether the plant needs to be pruned according to the plant properties and the plant status; and in response to the plant needing to be pruned, outputting a prompt indicating that the plant needs to be pruned to the user.

In some embodiments, the method further includes: determining whether the plant needs to be pruned according to the plant properties and the plant status, as well as various pruning goals; in response to the plant needing to be pruned under any pruning goal, determining that the plant needs to be pruned, wherein, the pruning goals include maintaining aesthetics, maintaining health, treating pests and diseases, facilitating flowering and facilitating fruiting.

In some embodiments, the method further includes: in response to the plant needing to be pruned, determining a pruning plan according to the plant properties, the plant status, and the corresponding pruning goal, the pruning plan includes a pruning approach and a pruning position; and depicting the pruning approach and the pruning position in combination with the one or more images to display the pruning plan to the user.

In some embodiments, the method further includes: in response to the plant needing to be pruned, determining a pruning time suitable for pruning the plant according to the plant properties, the plant status, and the corresponding pruning goal; and in response to the pruning time being later than the current time, setting a corresponding reminder according to the pruning time.

In some embodiments, the plant properties include the plant species. The plant status includes at least one of the plant growth stage, the plant health condition and the plant pests and diseases.

According to the sixth aspect of the embodiments of the present disclosure, a device for assisting users in plant cultivation is provided, including: a determining module, configured to determine a pruning plan according to a plant species and a pruning goal, and determine whether to display the pruning plan to the user according to the current season and/or the plant growth stage, the pruning plan includes a pruning approach and a pruning position; and a depicting module, configured to, in response to determining to display the pruning plan to the user, depict the pruning approach and the pruning position in combination with the image of the plant to display the pruning plan to the user.

According to the seventh aspect of the embodiments of the present disclosure, a device for assisting users in plant cultivation is provided, including: a memory; and a processor coupled to the memory, the processor is configured to execute the method described in any one of the above embodiments based on instructions stored in the memory.

According to the eighth aspect of the embodiments of the present disclosure, a non-transitory computer-readable storage medium is provided, including computer program instructions, wherein, when the computer program instructions are executed by a processor, the method described in any one of the above embodiments is implemented.

According to the ninth aspect of the embodiments of the present disclosure, a computer program product is provided, including a computer program, wherein, when the computer program is executed by a processor, the method described in any one of the above embodiments is implemented.

According to the tenth aspect of the embodiments of the present disclosure, a system for assisting users in plant cultivation is provided, including: a pruning device and a processor. The pruning device includes a camera and multiple pruning tools, wherein the camera is configured to recognize the position where the plant needs to be pruned, wherein the processor is configured to control the pruning device to move to the position and to perform pruning using the current pruning tool among the multiple pruning tools.

The technical plan of the present disclosure is further described in detail below through drawings and embodiments.

### BRIEF DESCRIPTION OF THE DRAWINGS

In order to explain the technical plans in the embodiments of the present disclosure or in the related art more clearly, a simple introduction will be given below to the drawings needed in the description of the embodiments or the related art. Clearly, the drawings described below are only some embodiments of the present disclosure. For ordinary skilled persons in the art, other drawings may be obtained based on these drawings without creative effort.

FIG. 1 is a flowchart of a method for assisting users in plant cultivation according to some embodiments of the present disclosure.

FIG. 2A to FIG. 2E are schematic diagrams of pruning tools in a method for assisting users in plant cultivation according to some embodiments of the present disclosure.

FIG. 3 and FIG. 4 are schematic diagrams of pruning precautions in a method for assisting users in plant cultivation according to some embodiments of the present disclosure.

FIG. 5A and FIG. 5B are schematic diagrams of tillering branches in a method for assisting users in plant cultivation according to some embodiments of the present disclosure.

FIG. 6A to FIG. 6C are schematic diagrams of pruning methods in a method for assisting users in plant cultivation according to some embodiments of the present disclosure.

FIG. 7A to FIG. 7D are schematic diagrams of crossing branches, retrograde branches, drooping branches, and parallel branches in a method for assisting users in plant cultivation according to some embodiments of the present disclosure.

FIG. 8 is a schematic diagram of a pruning plan in a method for assisting users in plant cultivation according to some embodiments of the present disclosure.

FIG. 9 is a schematic diagram of mature branch veins of a fruit plant in a method for assisting users in plant cultivation according to some embodiments of the present disclosure.

FIG. 10 is a schematic diagram of bud points in a method for assisting users in plant cultivation according to some embodiments of the present disclosure.

FIG. 11 and FIG. 12 are schematic diagrams of determination rules for pruning time in a method for assisting users in plant cultivation according to different embodiments of the present disclosure.

FIG. 13A to FIG. 13C are schematic diagrams of pruning plans for assisting users in plant cultivation according to some embodiments of the present disclosure.

FIG. 14 is a flowchart of a method for assisting users in plant cultivation according to some embodiments of the present disclosure.

FIG. 15 is a flowchart of a method for assisting users in plant cultivation according to some embodiments of the present disclosure.

FIG. 16 is a flowchart of a method for assisting users in plant cultivation according to some embodiments of the present disclosure.

FIG. 17 is a flowchart of a method for assisting users in plant cultivation according to some embodiments of the present disclosure.

FIG. 18 is a structural schematic diagram of a device for assisting users in plant cultivation according to some embodiments of the present disclosure.

FIG. 19 is a structural schematic diagram of a device for assisting users in plant cultivation according to some embodiments of the present disclosure.

### DETAILED DESCRIPTIONS OF THE EMBODIMENTS

The following will combine the drawings in the embodiments of the present disclosure to clearly and completely describe the technical plans in the embodiments of the present disclosure. Clearly, the described embodiments are only part of the embodiments of the present disclosure, not all embodiments. Based on the embodiments in this disclosure, all other embodiments obtained by those skilled in the art without creative effort are within the scope to be protected by this disclosure.

Unless otherwise specifically stated, the relative arrangement, numerical expressions and values of the components and steps described in these embodiments do not limit the scope of the present disclosure.

At the same time, it should be understood that, for ease of description, the dimensions of each part shown in the drawings are not drawn according to the actual proportional relationship.

For technologies, methods, and devices known to ordinary skilled persons in the related field, detailed discussions may not be provided, but in appropriate situations, the said technologies, methods, and devices should be considered as part of the specification.

In all examples shown and discussed here, any specific values should be interpreted as merely exemplary, and not as limitations. Therefore, other examples of exemplary embodiments may have different values.

It should be noted: similar numerals and letters in the following drawings indicate similar items, therefore, once an item is defined in one drawing, no further discussion is needed in the subsequent drawings.

The inventors have noticed that there are some application programs (Apps) in the related technology that may be installed on electronic devices such as computers, mobile phones, and so on, which may be used to provide functions related to plant cultivation, for example, providing users with introductions about plant species and cultivation information. These functions are particularly beneficial for novices in plant cultivation, or users who are not familiar with the cultivation information of specific plants.

The present disclosure have also noticed that pruning is extremely important for plant growth, and it is a relatively difficult operation for users who maintain plants. However, the cultivation information provided in the related technology may not involve pruning information; even if it involves pruning information, the description of pruning information is relatively brief, and users are not clear about how to prune specifically. Therefore, if detailed pruning guidance can be displayed to users, it will be more helpful for users to master plant cultivation methods and accumulate plant cultivation experience.

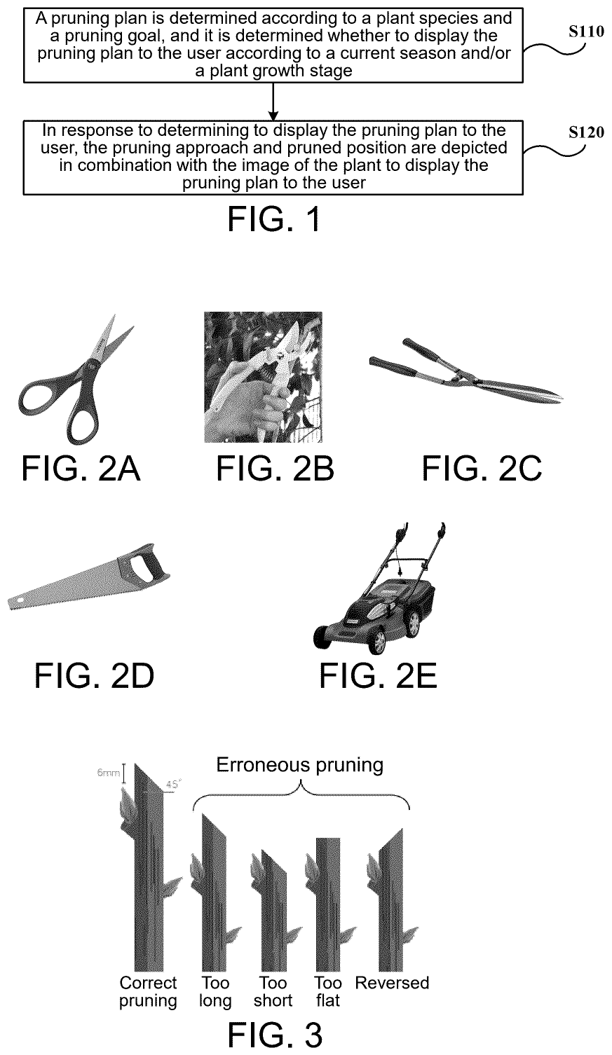

FIG. 1 is a flowchart of a method for assisting users in plant cultivation according to some embodiments of the present disclosure. The method may be executed by an application program installed on electronic devices such as computers, mobile phones, and so on to assist users in plant cultivation. The method may include step S110 and step S120 as described below.

In step S110, a pruning plan is determined according to a plant species and a pruning goal, and it is determined whether to display the pruning plan to the user according to a current season and/or a plant growth stage. The pruning plan may include, for example, a pruning approach and a pruning position.

In some embodiments, a plant species may constitute a category within botanical taxonomy, with its hierarchical classification potentially at the level of species (including subspecies), genus (including subgenus), or other taxonomic ranks. In some embodiments, plant species encompass, for example, woody plants and herbaceous plants. In other embodiments, plant species may include vegetables, fruits, shrubs, trees, roses, and hydrangeas, among others. In some embodiments, plant species may be classified in detail-taking hydrangeas as an example, plant species related to hydrangeas may include multiple varieties such as tree hydrangea, panicle hydrangea, oakleaf hydrangea, and endless summer hydrangea. Given that some hydrangea varieties may bloom on new wood, while others may bloom on old wood, if a pruning method appropriate for species that bloom on old wood is applied to species that bloom on new wood, the latter species will likely fail to flower after pruning. That is to say, even among hydrangeas, different species may correspond to different pruning methods. It is therefore evident that the more specific the identification of plant species, the more likely the determined pruning protocol will conform to the actual plant characteristics, enabling users to better maintain their plants.

In some embodiments, plant species may be directly obtained from users through human-computer interaction; and/or plant species may be obtained from images provided by the user through a computer vision technology. In some implementations, directly obtaining plant species from users through the human-computer interaction may include: displaying questionnaires related to plant species to users and obtaining plant species through users' responses. It should be understood that “directly” here is relative to the method of obtaining plant species from the image input by the user through the computer vision technology. In some implementations, the plant species recognition model may be pre-trained to identify plant species utilizing the computer vision technology. In some implementations, in cases where plant species are obtained from the image provided by the user at least through the computer vision technology, the pruning position and the pruning method may subsequently be annotated on the image provided by the user. In this way, it is possible to enable better presentation of pruning solutions, allowing users to more conveniently understand how they should prune. This helps to enhance user experience.

In some embodiments, the pruning goal may include one or more of maintaining aesthetics, maintaining health, treating pests and diseases, facilitating flowering, and facilitating fruiting. In some implementations, the pruning goal may be determined according to user needs. Some users have only the most basic requirements for the status of the plants they maintain, for example, only maintaining the health status of plants or treating plant pests and diseases. Some users have higher requirements for the aesthetics of plants, for example, they may have the need to maintain aesthetics. Some users expect that plants have some ornamental value, for example, they may have pruning goals of facilitating flowering or facilitating fruiting. In some implementations, the pruning goal may be obtained from the user, for example, an interactive questionnaire may be displayed to the user, and the pruning goal may be determined through the user's answers to the interactive questionnaire. In other implementations, the pruning goal may be determined according to plant species and so on. For example, if the plant species is hydrangea, the pruning goal may be determined as facilitating flowering. In another example, if the plant species is peach tree, the pruning goal may be determined as facilitating fruiting.

In some embodiments, the pruning plan may be determined according to both plant species and pruning goal. In other embodiments, the pruning plan may be determined according to plant species, pruning goal, and other factors. Other factors may include, for example, a plant health status, a plant growth speed, plant growth years, plant ecological features, plant ornamental properties, a plant growth space, a plant size, a plant age, plant morphological features, and user factors. How to determine the pruning plan will be further introduced in combination with some embodiments in the following description.

In some circumstances, the pruning plan may be correlated with seasons. For example, some plant species, under some pruning objectives, may be suitable for spring pruning, while others may be appropriate for early winter pruning, etc. In some embodiments, seasons may include spring, summer, autumn, and winter. In other embodiments, seasons may be further categorized based on temporal information, geographical location information, and climatic information. For instance, spring may be further categorized into early spring, mid-spring, and late spring. In a specific embodiment, due to climatic variations, the onset of spring in Beijing is likely to be approximately two weeks later than in Hangzhou, which may result in differences in the growth phases of plants in these two locations. Therefore, when determining the current season, a combination of temporal information, geographical location information, and climatic information may be collectively considered. For example, at the same current time, the current season in Beijing may be determined as early spring, whereas the current season in Hangzhou may be determined as mid-spring. Consequently, determining the season based on temporal information, geographical location information, and climatic information enables a more accurate determination of the season, thereby making the pruning plan more aligned with the actual conditions of the plant's environment, which helps the user to better perform plant maintenance.

In some situations, the pruning plan may be related to the plant growth stage. For example, some plant species, under some pruning goals, may be suitable for pruning during dormancy period, while others may be suitable for pruning during flowering period, etc. In some embodiments, the plant growth stages include growth period, dormancy period, flowering period, and fruiting period. In some embodiments, the plant growth stages may be further categorized, for example, they may include pre-flowering, during flowering, post-flowering, pre-fruiting, during fruiting, post-fruiting, and other stages.

In some embodiments, whether to display the pruning plan to the user may be determined according to the current season and/or the plant growth stage. In some implementations, the pruning plan may involve pruning time, thereby it may be determined whether the current season and/or the plant growth stage matches the pruning time involved in the pruning plan. If they match, the pruning plan may be displayed to the user; if they do not match, the pruning plan may not be displayed to the user. In some implementations, the pruning time may also include at least one of the suitable pruning season and the plant growth stage, for example, the pruning time may include post-flowering pruning, spring pruning, regular pruning during growth period, pruning during dormancy period, and post-fruiting pruning. For example, if the pruning plan indicates that the plant needs to be pruned in spring and after flowering, while the current season is winter and the plant growth stage is dormancy period, in this situation, the pruning plan may not be displayed to the user temporarily. However, as time passes, the pruning plan may be displayed to the user when the season changes to spring and the plant growth stage is flowering period. In some implementations, multiple candidate pruning plans may be determined according to the plant species and pruning goal, and whether each of the multiple candidate pruning plans needs to be displayed to the user may be determined according to the current season and/or the plant growth stage. For example, the pruning plan that matches the current season and/or the current plant growth stage may be selected from the multiple candidate pruning plans as the pruning plan to be displayed to the user.

In some embodiments, the pruning plan may include the pruning approach and the pruning position. Specifically, the pruning approach may include one or more of the pruning tool, the pruning method, and the pruning degree. FIG. 2A to FIG. 2E are schematic diagrams of pruning tools in the method for assisting user in plant cultivation according to some embodiments of the present disclosure. The pruning tool may include one or more of non-gardening scissors as shown in FIG. 2A, pruning shears as shown in FIG. 2B, hedge shears as shown in FIG. 2C, a pruning saw as shown in FIG. 2D, and a lawn mower as shown in FIG. 2E. Specifically, pruning shears may be used, for example, for pruning branches with a diameter not exceeding three-quarters of an inch, hedge shears may be used for pruning hedges and shrubs, and the pruning saw may be used for pruning woody branches larger than three-quarters of an inch.

The pruning method may include one or more of pruning broken branches, pruning dead branches, pruning weak branches, pruning diseased branches, pruning tillering branches, pruning drooping branches, pruning parallel branches, pruning crossing branches, pruning retrograde branches, pruning withered flowers, pruning new branches, pruning old branches, pinching, fruit thinning, and bud thinning. The pruning degree may be used to indicate the amount to be pruned. For example, the pruning degree may be “prune half of the branches”.

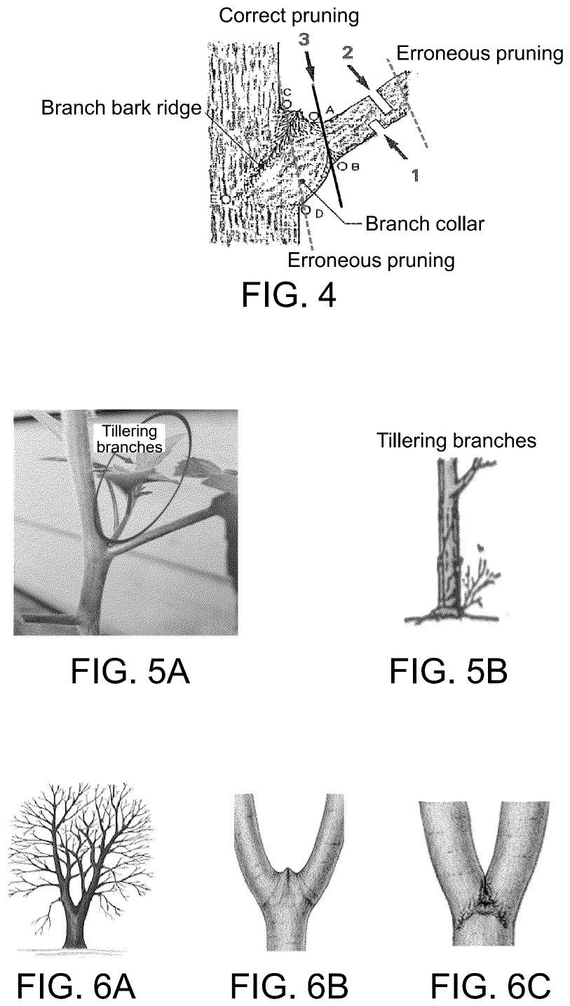

FIG. 3 and FIG. 4 are schematic diagrams of pruning precautions in a method for assisting users in plant cultivation according to some embodiments of the present disclosure.

In some embodiments, in addition to including pruning approach and pruning position, the pruning plan may also include one or more of pruning precautions, pruning principles, pruning theory, and pruning effects. Pruning precautions, for example, include wearing protective clothing when pruning roses-“Before pruning roses, please ensure you put on thick gardening gloves covering your arms, canvas pants or jeans, and a long-sleeved shirt or canvas jacket. Since the thorns on rose stems can cause various bacterial and fungal infections, one of which is sporotrichosis commonly known as rose picker's disease, these infections can be very serious, so it is best to wear protective clothing to avoid puncture wounds.” For another example, pruning precautions may include when pruning thin branches, tips, or stems, pruning needs to be done at the bud point or bud for shaping-“Cut the branches above the tender buds at a 45-degree angle outward, so that the stem grows outward, eventually forming the shape of a wine glass. When pruning, do not trim more than a quarter of the total number of stems/leaves of the plant each time to avoid affecting plant growth. Pruning should be neat, and the cuts should not be rough.” As shown in FIG. 3, the correct and incorrect pruning approaches when pruning thin branches, tips, or stems are illustrated. In another example, pruning precautions may include “When pruning thick branches, the cut needs to be made at the position from the branch bark ridge to the branch collar as shown in FIG. 4, so that the wound can heal well. Branches that need to be sawed should be pruned using the three-cut method as shown in FIG. 4, that is, making cuts at the positions marked as 1, 2, and 3 in the figure. This can prevent the bark of the branch from tearing and creating a crack on the trunk, which is beneficial for plant recovery. Branches that only require gardening shears can be further pruned, but the position of pruning is the same. The dashed line in FIG. 4 indicates the incorrect pruning approach, which should be avoided when pruning.” Displaying pruning precautions to the user is beneficial for the user to pay attention to some key points in the pruning plan, enabling the user to better master the pruning plan.

Pruning principles may include, for example, hard pruning and light pruning. In some embodiments, pruning principles may also include basically no pruning. Through displaying pruning principles to the user, it is beneficial for the user to establish an overall understanding of the pruning plan, facilitating the user to better understand the pruning plan.

Pruning theory includes, for example, “Pruning is best completed before the beginning of spring. Because at this time, there is less sap flow, which has less impact on the tree body, and shortly after this, the tree body begins to activate, which is conducive to wound healing.” Through displaying the pruning theory, the user can understand the internal logic of the pruning plan, which is beneficial for the user to better master the method of plant cultivation.

Pruning effects include, for example, “After pruning in this approach, the plant may quickly grow new branches and leaves, and the growth will be more vigorous at that time.” Through displaying the pruning effects, the user can know the possible results after the plant is pruned, which is beneficial for enhancing user experience.

In step S120, in response to determining to display the pruning plan to the user, the pruning approach and pruning position are depicted in combination with the image of the plant to display the pruning plan to the user.

In some embodiments, the plant image may be an image of the plant taken by the user. For example, pruning positions may be marked on the image of the plant taken by the user, and the pruning approach may be described in combination with the image of the plant taken by the user, thereby displaying the pruning plan to the user. In other embodiments, the plant image may be an exemplary image of the plant, for example, it may be an image from an image library. How to display the pruning plan to the user will be further introduced in combination with some embodiments in the following description.

In the above embodiment, firstly, the pruning plan is determined according to the plant species and pruning goal, which fully considers the plant situation and user requirements; secondly, it is determined whether to display the pruning plan to the user according to the current season and/or the plant growth stage, which is beneficial for ensuring that the pruning plan displayed to the user is a pruning plan that the user may currently execute; finally, the pruning approach and pruning position are depicted in combination with the image of the plant to display the pruning plan to the user, making the pruning plan vivid, simple, and easy to understand. In summary, the above embodiment may display a pruning plan to the user that fits the plant status and user requirements, which is beneficial for the user to master the method of plant cultivation.

The following combines some embodiments to introduce how to determine a pruning plan according to the plant species and the pruning goal.

In some embodiments, a pre-trained pruning recognition model may be used to determine the pruning plan according to the plant species and the pruning goal. As some implementations, pruning plans for various plant species may be obtained from channels such as the network, and combined with pruning plan determination rules formulated by plant experts to form a pruning plan database, then the pruning recognition model may be trained using the pruning plan database. The pruning plan determination rules here include, for example, rules for determining pruning plans based on plant species and other factors. As some implementations, the pruning recognition model may be used to determine the pruning approach and the pruning position. For example, the pruning recognition model may output multiple fields, and these fields collectively constitute the pruning plan. In a specific embodiment, in addition to including the pruning approach and pruning position, the pruning plan may also involve the plant species, pruning goal, pruning season, and plant growth stage. In this case, the pruning recognition model may output the plant species field, the pruning goal field, the pruning season field, the plant growth stage field, the pruning approach field, and the pruning position field.

In some embodiments, the pruning plan may be determined according to both plant species and pruning goal. In other embodiments, the pruning plan may be determined according to plant species, pruning goal, and other factors. These other factors may include one or more of the plant health status, the plant growth speed, the plant growth years, the plant ecological features, the plant ornamental properties, the plant growth space, the plant body size, the plant age, the plant morphological features, and user factors. Specifically, the plant growth years may include annual and perennial varieties. The plant ecological features include one or more of evergreen plants, deciduous plants, flowering plants, non-flowering plants, fruit plants, and non-fruit plants. Furthermore, flowering plants may include new branch/old branch flowering, and fruit plants may include new branch/old branch fruiting. The plant ornamental properties may include flowering/non-flowering properties. The plant growth space may include indoor space and outdoor space. The plant morphological features include one or more of single head/multiple heads, broken branches, dead branches, weak branches, diseased branches, tillering branches, drooping branches, parallel branches, crossing branches, and retrograde branches.

In some embodiments, when the pruning goal is to maintain aesthetics and the plant growth space is indoor space, the pruning plan may be to trim branches or stems, and pruning needs to be performed above the bud point or branch. The pruning plan may also include the pruning principle—“because branches or stems of indoor plants that grow too long will affect aesthetics.” The pruning plan may also include the pruning effect—“such pruning will facilitate the generation of new branches at the bud position, and the plant will grow more vigorously afterward.” Due to limited indoor growth space, some plants that grow very tall outdoors will have different pruning approaches when planted indoors versus outdoors. Therefore, by considering the plant growth space, it is conducive to determining the pruning plan according to local conditions.

In some embodiments, when the pruning goal is to maintain aesthetics, the plant species is shrub, and the plant body size is moderately appropriate, the pruning plan may be to trim off the newly grown tender leaves at the top of branches and leaves, and after the side branches of the branches grow longer again, secondary pruning and pinching may be performed, which is beneficial for growing robust and vigorous branches and leaves. In order to control the plant body size, strong pruning needs to be performed, therefore, the length of each trim needs to exceed the length of sprouting.

In some embodiments, when the pruning goal is to maintain health, and the plant species is succulent plant, the pruning plan may be root pruning, which means “when succulent plants are purchased for planting, the excess fibrous roots may be trimmed off, leaving only the main root, which is beneficial for the subsequent growth of the plant root system.”

In some embodiments, when the pruning goal is to maintain health, and the plant species is woody plant, the pruning plan may be to remove broken branches, dead branches, weak branches, or diseased branches. Since users are likely unable to accurately identify broken branches, dead branches, weak branches, or diseased branches, the pruning plan may also include pruning precautions-“one may determine whether dead branches exist by observing if the branches are dry and brittle, as well as the color of the branches. For branches that would normally appear green, if the branch is bright green, it indicates the branch is still healthy; if the branch is dark green, it indicates the branch is about to die; if the branch is brown, black, or dark gray, then this branch is already considered a dead branch.” In some embodiments, the pruning identification model may recognize whether branches are broken branches, dead branches, weak branches, or diseased branches, the pruning goal is to maintain health, the plant species is woody plant, and thus in situations where the plant morphological features indicate that the plant has broken branches, dead branches, weak branches, or diseased branches, the pruning plan may be determined to remove broken branches, dead branches, weak branches, or diseased branches by combining the pruning goal and the plant species.

In some embodiments, when the pruning goal is to maintain health, and the plant morphological features indicate that the plant has tillering branches, the pruning plan may be to remove tillering branches. FIG. 5A and FIG. 5B are schematic diagrams of tillering branches in a method for assisting users in plant cultivation according to some embodiments of the present disclosure. FIG. 5A and FIG. 5B both show exemplary images of tillering branches, which are secondary branches developed from tillering buds on tillering nodes or axillary buds inside leaf sheaths.

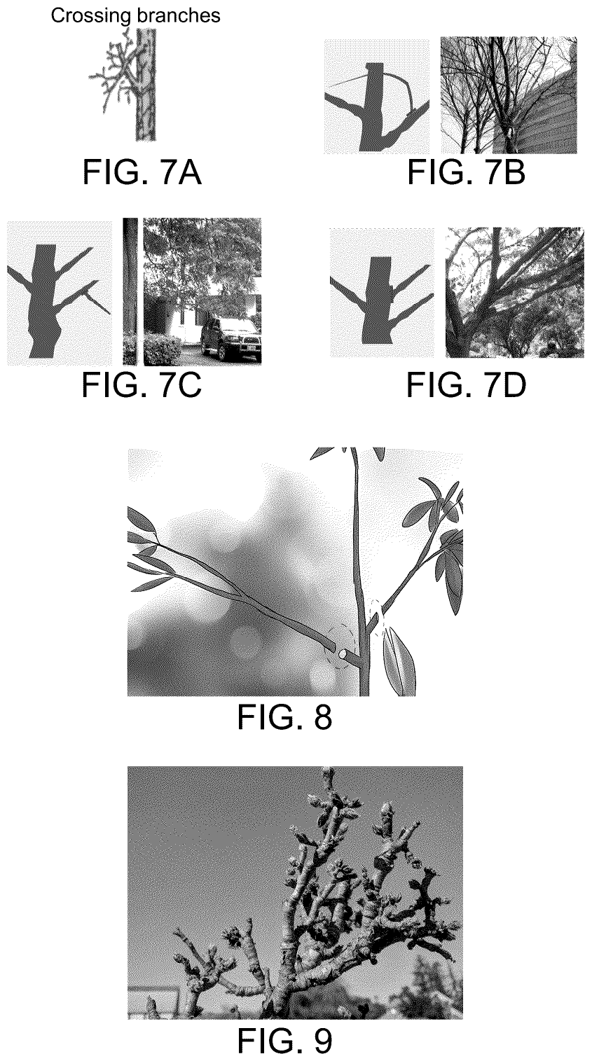

FIG. 6A to FIG. 6C are schematic diagrams of pruning methods in a method for assisting users in plant cultivation according to some embodiments of the present disclosure. FIG. 7A to FIG. 7D are schematic diagrams of crossing branches, retrograde branches, drooping branches, and parallel branches in a method for assisting users in plant cultivation according to some embodiments of the present disclosure. FIG. 8 is a schematic diagram of a pruning plan in a method for assisting users in plant cultivation according to some embodiments of the present disclosure.

In some embodiments, when the pruning goal is to maintain health, and the plant species is a tree, the pruning plan may include pruning principles, such as “selectively remove stems and branches, improve the structure and shape of the tree, to increase light penetration and air circulation throughout the crown, while making it unfavorable for pests to survive. It is best to ensure that the tree ultimately has an obovate shape (narrower at the top and wider at the bottom) as shown in FIG. 6A, which is beneficial for the tree's photosynthesis.” Furthermore, the pruning approach in the pruning plan may also include three parts: first is pruning large branches, for example, retaining U-shaped branches as shown in FIG. 6B during pruning, and removing one of the V-shaped branches as shown in FIG. 6C. Second is pruning crossing branches as shown in FIG. 7A, retrograde branches as shown in FIG. 7B, drooping branches as shown in FIG. 7C, and parallel branches as shown in FIG. 7D, which can increase ventilation and light exposure, reduce pathogen infection, and make the plant grow more vigorously. Furthermore, the pruning plan may also include pruning principles and precautions. For example, “retrograde branches occur during the growth stage due to dry climate or external force intervention, causing branches or their new buds to grow in reverse direction, seriously affecting the aesthetics of the overall tree shape and interfering with the reasonable growth space of other branches, therefore they can be identified as one of the undesirable branches”, “drooping branches refer to the situation where the direction of new buds grows downward, or when the growth angle of branches differs greatly from the growth angle of other branches, such as causing an imbalanced form, seriously affecting the aesthetics of the overall tree structure, they can be removed. However, if the tree itself is prone to producing drooping branches, such as cercis, weeping cherry, or willow trees, pruning is not necessary”, “parallel branches are branches that grow in directions and positions that form parallel lines above and below each other, one should consider the overall structure and balance to select one of them for removal, to prevent the upper branch from affecting the sunlight conditions of the lower branch, and the lower branch from competing for water and nutrients with the upper branch”, “when pruning parallel branches, one may keep the strong and remove the weak”, etc. Third is removing excess branches. As shown in FIG. 8, if there are multiple branches in the vertical direction, the pruning plan may be to keep the most vertical one and trim the other branches to their ends.

In some embodiments, the pruning goal may be to maintain health. As some implementations, the pruning plan may be determined by combining the pruning goal and the health status of the plant. The health status of the plant may include, for example, healthy, water deficient, overcrowded plants, and yellowing leaves.

For example, when the pruning goal is to maintain health, the plant species is a woody plant or herbaceous plant, and the plant health is poor, the pruning plan may be to cut back branches. For example, plants typically become unhealthy due to improper watering or repotting, such as becoming wilted. To help the plant recover quickly, the pruning plan may be to cut back branches to reduce nutrient consumption, and after the plant grows new roots, the plant can recover quickly. After recovery, the plant can rapidly grow new branches and leaves, and at that time, the growth will be more vigorous. As another example, when the pruning goal is to maintain health and the plant health status shows yellowing or smaller leaves at the lower part of the plant, since this may be caused by the dense foliage at the upper part blocking sunlight from reaching the lower part, the pruning plan may be to appropriately trim the upper leaves.

As some implementations, the health status of the plant may be obtained through a plant health recognition model. For example, the plant health recognition model may process text related to the plant and/or images related to the plant input by the user, thereby determining the health status of the plant.

In some embodiments, the pruning goal may be to treat pests and diseases, which may include, for example, anthracnose, root rot, leaf mold, young fruit mold, whiteflies, and red spiders. As some implementations, the pruning plan may be determined by combining the pruning goal and the pests and diseases of the plant. For example, when the pruning goal is to treat pests and diseases, and the plant has moldy leaves, the pruning plan may be to remove the moldy leaves.

As some implementations, the pests and diseases of the plant may be obtained through a plant pest and disease recognition model. For example, the plant pest and disease recognition model may process text related to the plant and/or images related to the plant input by the user, thereby determining the pests and diseases of the plant.

In some embodiments, when the pruning goal is to promote flowering, and the plant species is a woody plant or herbaceous plant, the pruning plan may be deadheading, which means “removing withered flowers to reduce continued nutrient consumption, allowing the plant to quickly resume growth and become more vigorous.” Furthermore, the pruning plan may also include pruning precautions-“when pruning, the flower stalk needs to be removed as well.”

In some embodiments, when the pruning goal is to promote fruiting, and the plant species is a woody plant or herbaceous plant, the pruning plan may be pinching, for example, “pinching after fruit set, removing the stem and leaves above the second large leaf from the top of the branch. This can prevent continued growth of the plant stems and leaves, reduce vegetative growth, and promote reproductive growth”.

In some embodiments, when the pruning goal is to promote fruiting, and the plant species is a woody plant or herbaceous plant, the pruning plan may be fruit thinning, for example, “since flowers or fruits growing too densely will compete with each other for nutrients, it is necessary to remove underdeveloped flowers and smaller fruits to prevent the plant from failing to provide adequate nutrition leading to fruit drop, or preventing the fruits from ripening properly”.

In some embodiments, when the pruning goal is to promote fruiting, and the plant species is a citrus tree, the pruning plan may be pruning the bottom branches.

In some embodiments, when the plant species is a cherry tree, pruning precautions may be displayed to the user—“cherry trees do not need pruning for the purpose of promoting flowering or promoting fruiting”.

In some embodiments, the pruning method may be determined according to the plant species, the plant growth stage, and the plant growth rate. For example, when the pruning goal is to promote fruiting, and the plant species is a peach tree or kiwi tree, due to the fast growth rate of peach trees or kiwi trees, the extent of pruning in the pruning plan may be determined as “pruning half of the branches from the previous year.” For another example, when the pruning goal is to promote fruiting, and the plant species is an apple, pear, cherry, or plum tree, due to the slow growth rate of apple, pear, cherry, or plum trees, the extent of pruning in the pruning plan may be determined as “only need to trim one-fifth of the branches from the previous year.” For yet another example, the pruning frequency may be determined according to the growth rate of the plant. As some implementations, the growth rate of the plant may be determined according to information provided by the user. For example, the user may provide at least two images of the same plant taken at different times, and the pruning recognition model may determine the growth rate of the plant according to these at least two images.

In some embodiments, when the plant species is a fruit tree and the pruning goal is to maintain health, the pruning plan may be pruning drooping branches, parallel branches, crossing branches, and retrograde branches, etc., thereby increasing ventilation and light exposure, reducing pathogen infection, and making the fruit tree grow more vigorously. When pruning parallel branches, it is necessary to keep the strong ones and remove the weak ones. Furthermore, the pruning plan may also include retaining auxiliary branches growing at an angle of about 45 degrees outward, and removing branches with angles that are too large or too small. In addition, because horizontally growing branches produce more fruit than vertically growing branches, if there are too many horizontally growing branches, it will lead to too many fruits, which is not conducive to the long-term growth of the plant. Therefore, some of the horizontal branches need to be trimmed.

FIG. 9 is a schematic diagram of mature branch veins of a fruit plant in a method for assisting users in plant cultivation according to some embodiments of the present disclosure.

In some embodiments, when the plant species is a fruit tree and the pruning goal is to promote fruiting, the pruning plan may also be determined by considering whether the plant fruits on new branches or old branches. For example, when the plant fruits on old branches, since fruit trees that fruit on old branches will bear fruit on mature spurs as shown in FIG. 9, and the fruiting time may last for decades, it is necessary to avoid pruning off the mature spurs when pruning. Therefore, the pruning plan may be lightly trim old branches and cultivate new mature spurs, thereby promoting fruiting. In addition, since many mature spurs will gradually form after the fruit tree shape is determined, if the mature spurs are dense, removing some mature spurs will increase the size and quality of the fruits formed on the remaining mature spurs. Fruit trees that fruit on old branches include apple, pear, plum, cherry, and apricot.

In some embodiments, when the ecological feature of the plant is an evergreen fruit tree, the new buds may be trimmed according to the pruning principle of removing the weak and keeping the strong. In addition, if the branches are too long, the nutritional plant type needs to be pinched to ensure the plant type and sufficient nutrition for fruiting.

In some embodiments, when the ecological feature of the plant is fruiting on new branches, since the fruiting branches of fruit trees that fruit on new branches are new branches or branches from the following year, the pruning plan may be to trim old branches, which may promote the growth of new branches, thereby promoting fruiting. Fruit trees that fruit on new branches include Casimiroa edulis, Persea americana, Acca sellowiana, Olea europa, kiwi tree, citrus, jujube tree, Psidium littorale, Eriobotrya japonica, fig, persimmon, and Cydonia oblonga.

In some embodiments, when the plant is a tropical fruit tree, for example, in the case of a lychee tree, the pruning plan may be to cut off about 4 inches (10 centimeters) of the fruiting branch tips after the fruit tree harvest. Furthermore, the pruning plan may also include the pruning principle—“This pruning plan can ensure that new fruiting branch tips will form at the same location for the next crop”.

In some embodiments, the pruning plan may be determined according to the plant species, pruning goal, and plant ecological features (for example, including the plant flowering time). Table 1 shows the correspondence between the flowering time of clematis and the pruning principles and pruning approaches in the pruning plan according to some embodiments of the present disclosure.

TABLE 1

| | Pruning | |
|---|---|---|
| | principles | Pruning method |
| Clematis species | Minimal | If it is desired to control the plant |
| that flower before | pruning | size, it is possible to perform |
| February to May | | pruning immediately after flowering |
| Clematis species | Light | If it is desired to control the size of |
| that flower in | pruning | the plant, it is necessary to perform |
| May to June | | pruning in early spring, pruning is |
| | | performed above the axillary buds |
| Clematis species | Hard | This type of species grows relatively |
| that flower in | pruning | vigorously, after growth resumes in |
| late summer | | early spring, prune them to |
| and autumn | | 30 centimeters |

As shown in Table 1, the pruning plan for clematis species that flower before February to May may be to trim immediately after flowering. The pruning plan for clematis species that flower in May to June may be to trim in early spring, and to trim above the axillary buds. Clematis species that flower in late summer and autumn may be trimmed to 30 centimeters after they begin to resume growth in early spring.

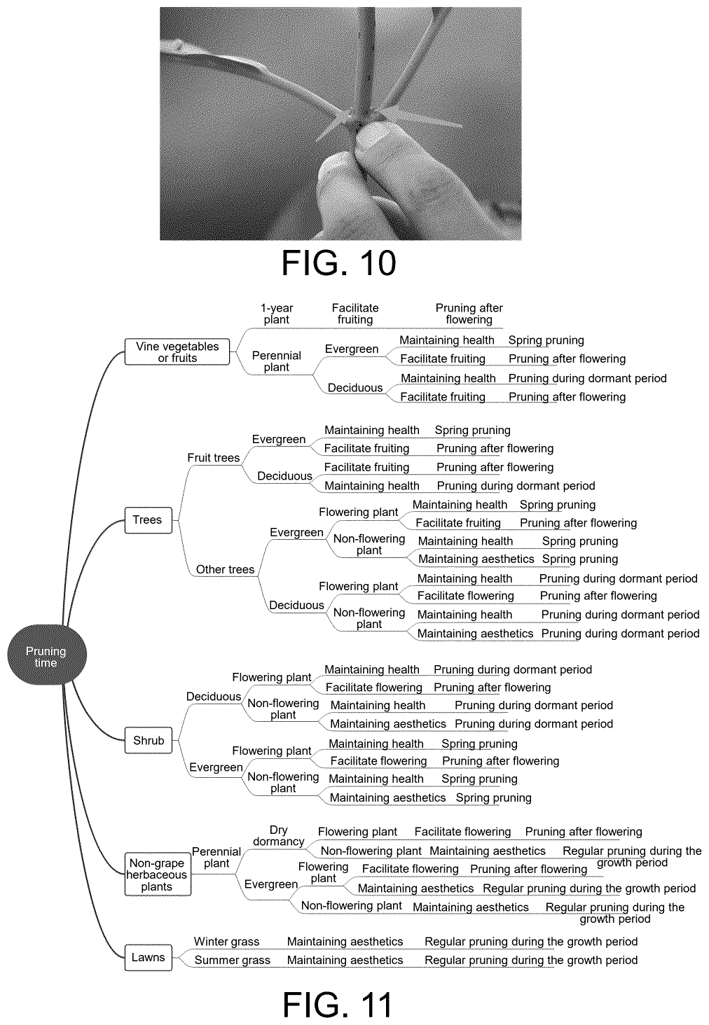

FIG. 10 is a schematic diagram of bud points in a method for assisting users in plant cultivation according to some embodiments of the present disclosure.

In some embodiments, the pruning plan may be determined according to the plant species, the pruning goal, and the plant ecological features (flowering on new/old branches). Taking hydrangeas as an example, hydrangeas that flower on new branches include: H. arborescens, H. paniculata, and limelight hydrangeas. Species that flower on old branches include H. quercifolia, H. serrata, H. anomala subsp. petiolaris, mophead, macrophylla, lacecap and oakleaf varieties.

Species that can flower on both new and old branches include endless summer. The pruning plan for hydrangeas that flower on new branches may be: trim branches that grew last year once a year, which can make flowers more productive and larger. Branches that grew last year are pruned to the lowest pair of healthy buds, thus forming a low woody branch framework. After such pruning, the framework height of the plant is generally no more than 25 centimeters (10 inches). If a greater height is needed, the plant may be trimmed to about 60 centimeters (2 feet) high. In addition, neglected plants usually respond well to harder pruning to restore a low framework. For hydrangeas that flower on old branches, the pruning plan may be to trim immediately after flowering because flower buds will differentiate and form after flowering, and pruning during dormant period will affect the plant flowering in the following year. At this time, pruning may be done for shaping; if it is not desired for the plant to grow too tall, it is possible to shorten the branches, cutting off up to two-thirds of the original length; if it is desired for the plant to maintain its original shape, light pruning may be performed. Whether hard pruning or light pruning, either needs to be done above the buds pointed to by the arrow in FIG. 10, because these are the branches that will flower in the coming year.

The following combines some embodiments to introduce how to determine whether to display the pruning plan to the user according to the current season and/or the plant growth stage.

In some embodiments, the pruning plan may involve pruning time, whereby it may be determined whether the current season and/or plant growth stage matches the pruning time involved in the pruning plan. If it matches, the pruning plan is displayed to the user; if it does not match, the pruning plan is not displayed to the user. As some implementations, the pruning time may include suitable pruning seasons and suitable plant growth stages for pruning. For example, the pruning time may include pruning after flowering, spring pruning, regular pruning during the growth period, pruning during dormant period, pruning after fruit setting, and winter pruning.

For example, the pruning time may be pruning after flowering. In this situation, it may be determined whether the plant has finished flowering by combining the current season and/or the current plant growth stage. If the plant has finished flowering, the pruning plan is displayed to the user. Of course, if the plant has not finished flowering at this time, the pruning approach may not be displayed to the user currently. After the plant has finished flowering, then the pruning plan is displayed to the user.

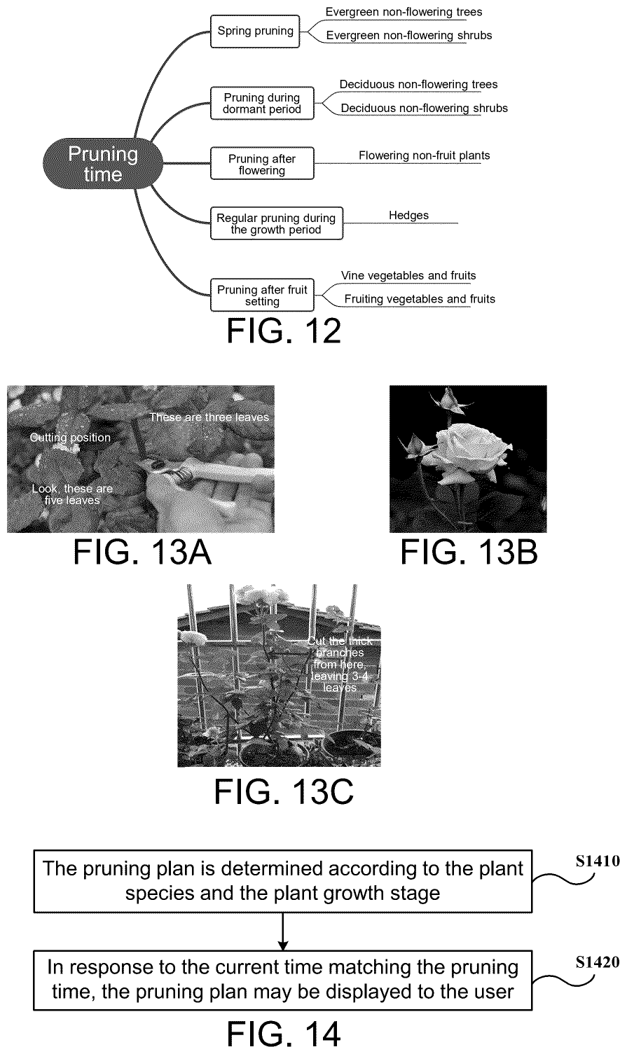

FIG. 11 and FIG. 12 are schematic diagrams of determination rules for pruning time in a method for assisting users in plant cultivation according to different embodiments of the present disclosure.

As shown in FIG. 11, the pruning time may be determined according to plant species, pruning goal, and other factors, where the other factors may refer to the description above. For example, when the plant species is vine vegetables or fruits, the plant growth period is 1-year plant, and the pruning goal is to facilitate fruiting, the pruning time may be determined as pruning after flowering. For another example, when the plant species is fruit tree, the plant ecological feature indicates that the plant is an evergreen plant, and the pruning goal is to maintain health, the pruning time may be determined as spring pruning. For example, when the plant species is shrub, the plant ecological feature indicates that the plant is a deciduous plant and a flowering plant, and the pruning goal is to facilitate flowering, the pruning time may be determined as spring pruning. For example, when the plant species is lawn, the plant ecological feature indicates that the plant is a warm-season grass, and the pruning goal is to maintain aesthetics, the pruning time may be determined as regular pruning during the growth period.

As shown in FIG. 12, the pruning time for evergreen non-flowering trees and evergreen non-flowering shrubs may be spring pruning. The pruning time for deciduous non-flowering trees and deciduous non-flowering shrubs may be pruning during dormant period. The pruning time for hedges may be regular pruning during the growth period. The pruning time for vine vegetables and fruits may be pruning after fruit setting; furthermore, the pruning time may be topping after fruit setting. The pruning time for fruiting vegetables and fruits may be pruning after fruit setting; furthermore, the pruning time may be fruit thinning after fruit setting.

In some embodiments, pruning after flowering may include the following situations. First, flowering non-fruit plants may have their withered flowers trimmed after flowering, which can concentrate nutrients and make the plant grow better. Second, perennial plants that flower on old branches may be trimmed overall after flowering, and should be trimmed immediately after flowering to maximize flowering time for the following year; if trimmed during the dormant period, it will affect the plant flowering in the following year. Moreover, pruning the plant immediately after flowering allows for shaping, because flower buds will differentiate and form after flowering. Flowering non-fruit plants and perennial plants that flower on old branches include, for example, pieris, rhododendron, forsythia, lilac, spirea, such as bridal wreath and vanhouttei, dogwood, flowering cherry and plum trees, and some hydrangeas. Third, vine vegetables and fruits may also be trimmed after flowering, for example, by pinching or thinning fruits after flowering.

In some embodiments, spring pruning may include the following situations. First, perennial plants that flower on new branches may be trimmed before spring budding. Perennial plants that flower on new branches include, for example, clematis, butterfly bush, roses, crape myrtle, privet, and some hydrangeas, such as H. arborescens, H. paniculata, limelight hydrangeas, endless summer, etc. Second, most trees and shrubs, especially those that flower on newly grown branches in the current season, may be trimmed at the end of winter or early spring before new growth, and during pruning, the flower stems of the previous year may be trimmed to within one or two buds of the old woody framework. Third, evergreen ornamental foliage trees may also be trimmed after new buds grow in spring; evergreen ornamental foliage trees include, for example, arborvitae, holly, boxwood, juniper, yew, etc.

In some embodiments, lawns and indoor evergreen herbaceous vines may be regularly trimmed during the growth period.

In some embodiments, pruning during dormant period may include the following situations. First, deciduous shrubs and trees that are not grown for their flowers may be trimmed during the dormant period, and it is best to limit pruning to removing dead or damaged branches. In cold areas, the pruning time should preferably be before budding to prevent winter damage to cut surfaces. In warm areas, pruning time should preferably be after leaf fall, because nutrients have returned to the roots by then, and wounds can heal within the year. Winter pruning is generally appropriate 20 to 40 days before tree activation; winter pruning is best completed before the beginning of spring, because at this time sap flow is reduced, the impact on the tree is smaller, and shortly thereafter the tree begins to activate, which is conducive to wound healing. Second, herbaceous plants whose above-ground parts die after dormancy may be trimmed during the dormant period.

FIG. 13A to FIG. 13C are schematic diagrams of pruning plans for assisting users in plant cultivation according to some embodiments of the present disclosure.

As some implementations, the pruning time for a plant may include multiple times. Taking the plant species of rose as an example, the pruning time may include spring pruning, pruning after the first flowering, pruning after flowering except for the first flowering, and pruning during dormant period. Specifically, the spring pruning plan is, for example, when buds are removed from roses, that is, when the buds have just grown out, inner buds and secondary buds may be removed; if multiple new buds appear at one bud point, the strongest bud may be retained, preferentially the strong outer buds may be selected for retention, and 3 to 4 buds may be retained on a 35-centimeter branch. When the buds grow to 3 to 4 centimeters, 1 bud may be kept on one branch.

The pruning plan for roses after the first flowering may be divided into two types according to the morphological features of the plant-single-headed/multi-headed. For single-headed species, as shown in FIG. 13A, a single-headed species has one flower on one branch, and the branch is relatively thick and strong. When pruning, the spent flower should be trimmed together with the first five-leaflet leaf, generally the third leaf counting down from the spent flower. For multi-headed roses, as shown in FIG. 13B, multi-headed roses will simultaneously grow many flower buds on one branch, if no thinning of buds is performed and they open naturally, there will be differences in the timing of the flower buds opening, therefore, the main flowers that are about to fade may be cut off first, and after the other flower buds open normally, pruning may be performed. Subsequent pruning may involve leaving 3 to 4 leaves on strong branches, 2 to 3 leaves on medium branches, and 1 to 2 bud points on the outer side of weak branches to facilitate the sprouting of new strong branches.

The pruning plan for roses after flowering except for the first flowering may be as shown in FIG. 13C. Since this is often in summer when temperatures are relatively high and the rose's growth begins to weaken, light pruning may be performed, promptly removing spent flowers and water sprouts, pruning below the second leaf under the spent flower, without cutting away too many branches and leaves to avoid reducing the area for photosynthesis.

The pruning plan for roses during the dormant period is, for example, selecting thick and strong flowering branches that grew out in spring and summer, keeping 2 to 3 buds from the base upward, and cutting away the rest. Diseased and weak branches, dead branches, crossing branches, and rootstock suckers should be cut away as much as possible. When pruning, try to cut weak branches strongly and strong branches lightly, so that after sprouting next spring, the height will be consistent, and flowering will be more uniform.

In some embodiments, for plant species that flower in spring and do not bear fruit, pruning may be performed after flowering for shaping. For plant species with fruits that ripen in autumn, pruning may be performed after fruit setting or in winter for shaping. In some embodiments, in early spring after buds appear, tip pruning may be performed on fruit trees, for example, the main stem may be pruned to 75 to 85 centimeters. In this way, the branches that grow in the future will be between 10 to 30 centimeters.

FIG. 14 is a flowchart of a method for assisting users in plant cultivation according to some embodiments of the present disclosure. As shown in FIG. 14, the method for assisting users in plant cultivation includes step S1410 and step S1420.

In step S1410, the pruning plan is determined according to the plant species and the plant growth stage. Here, the pruning plan may include descriptions of the pruning approach and pruning time, as well as markings of the pruning position. The pruning time may include, for example, the pruning season. The plant species, the plant growth stage, pruning approach, pruning time, and pruning position may refer to the descriptions above and will not be repeated here.

In step S1420, in response to the current time matching the pruning time, the pruning plan may be displayed to the user. For example, in a situation where the pruning time indicates that the plant should be trimmed in spring, if the current time is spring, the pruning plan may be displayed to the user.

In some embodiments, the pruning plan may be determined according to the plant species, the plant growth stage, and other factors. Other factors may include, for example, one or more of the pruning goal, the plant health status, the plant growth speed, the plant growth years, the plant ecological features, the plant ornamental properties, the plant growth space, the plant size, the plant age, the plant morphological features, and user factors. These other factors may refer to the descriptions above and will not be repeated here.

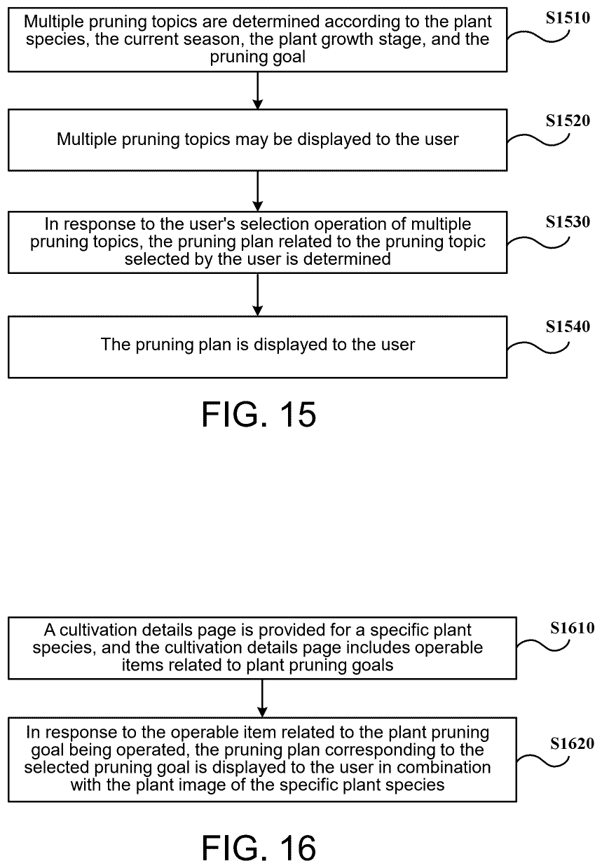

FIG. 15 is a flowchart of a method for assisting users in plant cultivation according to some embodiments of the present disclosure. As shown in FIG. 15, the method for assisting users in plant cultivation includes step S1510, step S1520, step S1530, and step S1540.

In step S1510, multiple pruning topics are determined according to the plant species, the current season, the plant growth stage, and the pruning goal. The plant species, the current season, the plant growth stage, and the pruning goal may refer to the descriptions above. As some implementations, one pruning goal may correspond to multiple pruning topics. For example, the pruning topics corresponding to the pruning goal of maintaining aesthetics may include different shapes of the plant, different sizes, aesthetic effects, etc. As another example, the pruning goal of maintaining health may also correspond to multiple pruning topics.

In step S1520, multiple pruning topics may be displayed to the user.

In step S1530, in response to the user's selection operation of multiple pruning topics, the pruning plan related to the pruning topic selected by the user is determined. For example, each pruning topic may correspond to a pruning plan, thereby determining the pruning plan according to the pruning topic selected by the user.

In step S1540, the pruning plan is displayed to the user.

In some embodiments, the pruning plan may also be recommended to the user according to user factors. User factors may include, for example, the user's preferences for pruning goals, preferences for pruning topics, etc. User factors may be determined, for example, according to the user's historical operation records. By recommending the pruning plan to the user, it is beneficial to save the user's time while providing a pruning plan that meets the user's needs, which is conducive to enhancing the user experience.

FIG. 16 is a flowchart of a method for assisting users in plant cultivation according to some embodiments of the present disclosure. As shown in FIG. 16, the method for assisting users in plant cultivation includes step S1610 and step S1620.

In step S1610, a cultivation details page is provided for a specific plant species, and the cultivation details page includes operable items related to plant pruning goals. The pruning goals may include, for example, one or more of maintaining aesthetics, maintaining health, treating pests and diseases, facilitating flowering, and facilitating fruiting. As some implementations, the specific plant species may be specified by the user. For example, the user may designate a specific plant species by entering the species through a search box.

In step S1620, in response to the operable item related to the plant pruning goal being operated, the pruning plan corresponding to the selected pruning goal is displayed to the user in combination with the plant image of the specific plant species. Here, the pruning plan is determined at least based on the specific plant species and the selected pruning goal.

In the above embodiments, not only is the plant cultivation details page displayed to the user, but also in response to the user's operation, the pruning plan corresponding to the pruning goal selected by the user may be displayed to the user, which is beneficial for the user to further understand the pruning plan that matches the user's pruning goal while learning about cultivation knowledge, thereby effectively enhancing the user experience.

In some embodiments, the pruning plan may be determined based on the specific plant species, the selected pruning goal, the current season, and the growth stage of the plant. In other embodiments, the pruning plan may be determined based on the specific plant species and the selected pruning goal, without being based on the current season and the plant growth stage. This approach, even if the current season and the plant growth stage do not match the season and growth stage applicable to the pruning plan, the pruning plan may still be displayed to the user, which is beneficial to satisfy the user's current desire to understand the pruning plan for the plant.

In some embodiments, in response to the selected pruning goal including maintaining aesthetics, multiple pruning topics are provided. In response to at least one pruning topic among the multiple pruning topics being selected, the pruning plan corresponding to the selected pruning topic is displayed to the user. The pruning topics may refer to the description above.

In some embodiments, under the corresponding pruning goal, the pruning plan includes the pruning time, the pruning position, the pruning tool, the pruning method, and the pruning degree for the specific plant species. The pruning time, the pruning position, the pruning tool, the pruning method, and the pruning degree may refer to the relevant description above.

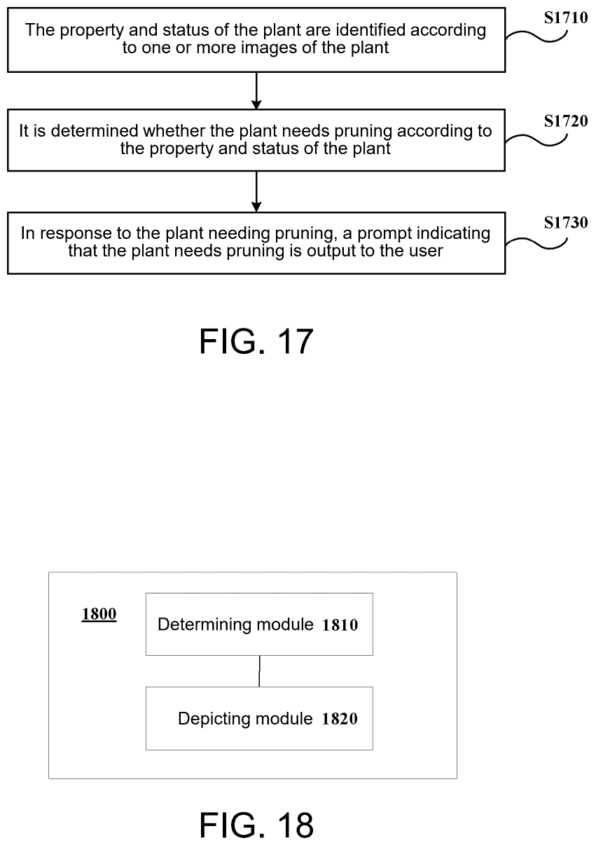

FIG. 17 is a flowchart of a method for assisting users in plant cultivation according to some embodiments of the present disclosure. As shown in FIG. 17, the method for assisting users in plant cultivation includes step S1710, step S1720, and step S1730.

In step S1710, the property and status of the plant are identified according to one or more images of the plant. The property of the plant may include, for example, the plant species, the plant status may include at least one of the plant growth stage, the plant health condition, and the pests and diseases of the plant. The plant species, the plant growth stage, the plant health condition, and the pests and diseases of the plant may refer to the description above.

In step S1720, it is determined whether the plant needs pruning according to the property and status of the plant. For example, it may be determined that the plant needs pruning based on the plant species and the pests and diseases of the plant.

In step S1730, in response to the plant needing pruning, a prompt indicating that the plant needs pruning is output to the user. For example, the pruning prompt may be displayed on a page used to display the property and status of the plant to the user. For example, the time to display the pruning prompt may be determined according to the pruning time involved in the determined pruning plan.

In the above embodiments, after performing plant recognition and plant diagnosis, it is automatically determined whether the plant needs pruning, which not only meets the user's needs for plant recognition and plant diagnosis, but also spontaneously outputs pruning suggestions to the user, which helps improve the user experience. In addition, combining plant recognition and plant diagnosis with the determination of plant pruning helps to fully utilize the information such as the property and status of the plant obtained through plant recognition and plant diagnosis, which helps save computational resources.

In some embodiments, it may be determined whether the plant needs pruning according to the property and status of the plant, as well as various pruning goals. In response to the plant needing pruning under any pruning goal, it is determined that the plant needs pruning. Here, the pruning goals may include maintaining aesthetics, maintaining health, treating pests and diseases, facilitating flowering, and facilitating fruiting.

In some embodiments, in response to the plant needing pruning, the pruning plan is determined according to the property of the plant, the status of the plant, and the corresponding pruning goals. Here, the pruning plan may include the pruning approach and pruning position, which may later be depicted in combination with one or more images to display the pruning plan to the user.

In some embodiments, in response to the plant needing pruning, the appropriate pruning time for the plant is determined according to the property of the plant, the status of the plant, and the corresponding pruning goals; and in response to the pruning time being later than the current time, a corresponding reminder is set according to the pruning time. For example, if it is determined that the pruning should be spring pruning according to the property of the plant, the status of the plant, and the corresponding pruning goals, while the current time is winter, the time for the pruning reminder may be set to a specific period in spring, so that the user can perform the pruning in a timely manner after receiving the reminder.

In some embodiments, while displaying the pruning plan to the user, a cleaning plan may also be displayed to the user. The cleaning plan may include, for example, cleaning dead branches and diseased leaves, cleaning fallen leaves, cleaning ground residual plants, and cleaning aging and yellowing leaves.

In some embodiments, the system for assisting the user in plant cultivation includes a pruning device and a processor. The pruning device includes a camera and multiple pruning tools. The camera is configured to recognize the position where the plant needs pruning. The processor is configured to control the pruning device to move to the position to perform pruning using the current pruning tool among the multiple pruning tools.

In some embodiments, the camera recognizes whether the current pruning tool is appropriate. When the camera recognizes that the current pruning tool is inappropriate, the processor controls the pruning device to replace the current pruning tool with another pruning tool among the multiple pruning tools.

In some embodiments, the system controls the pruning tool to perform pruning in a linked manner according to the recognition results of the camera. The camera generates a signal to the processor according to the position where the plant needs pruning. The camera further outputs a signal to the processor, which in turn links the processor to control the current pruning tool to move to the position where the plant needs pruning, so as to control the pruning device to execute the pruning operation. The camera recognizes whether the plant meets the standard after the pruning operation is completed. In other words, the camera may recognize whether the effect meets the requirements after the plant pruning is completed.

In some embodiments, the pruning device further includes a multi-segment pruning arm. The multi-segment pruning arm is configured to perform stretchable movement as well as control the angle of each segment of the pruning arm. In this approach, the multi-segment pruning arm performs pruning at different angles according to the pruning operation.

In some embodiments, the pruning device is a drone device. The camera and multiple pruning tools are integrated into the drone device. The camera on the drone device is configured to recognize the target plant, and then the intelligent unmanned aerial vehicle adjusts its own position to a suitable height for pruning according to the recognition results, and then activates the cutting device (i.e., the pruning device).

In some embodiments, the drone device adjusts its own position to a suitable height for pruning according to the recognition results of the target plant, and activates the current pruning tool.

In some embodiments, the system for assisting the user in plant cultivation also includes a front-end guiding device, which is disposed on the drone device. The front-end guiding device guides the target plant into the cutting range of the pruning device to execute the pruning operation.

In some embodiments, the system for assisting the user in plant cultivation further includes an airflow guiding device, which is disposed on the drone device. The airflow guiding device guides the airflow around the drone device, thereby avoiding the impact of the airflow formed by the rotation of the flight blades of the drone device on the pruning of the target plant. After the pruning operation is completed, the airflow guiding device blows the trimmed branches and leaves to a default position, and collects the trimmed branches and the leaves.

In some embodiments, the system for assisting the user in plant cultivation further includes a pruning waste sweeping device, which is disposed on the drone device. The pruning waste sweeping device processes the trimmed branches and leaves through one of suction and blowing methods to shred the trimmed branches and leaves.

In some embodiments, the pruning waste sweeping device performs waste processing on branches and leaves to convert them into fertilizer. Then, the pruning waste sweeping device performs fertilization processing.

In some embodiments, the pruning waste sweeping device moves the branches and leaves to a fixed position.

In some embodiments, the camera scans the plant to build a model. The model generates a pruning plan according to the recognition results of the camera to determine the pruning position and pruning approach. Moreover, the system marks the pruning position and pruning approach on the model to enable the pruning device to perform pruning.

In some embodiments, when there are multiple plants, the processor builds a model based on the positions of multiple plants as a whole to plan the optimal pruning path. The processor transmits the optimal pruning path to the pruning device to enable the pruning device to execute the pruning operation. In this embodiment, the pruning device is a drone device.

In some embodiments, the system for assisting the user in plant cultivation further includes a camera device, where the camera device recognizes and captures multiple plant images, and transmits them to the processor. In other words, the overall modeling may be completed by the camera of the drone or mobile pruning device, or it may be completed by other camera devices. The processor builds a model according to multiple plant images to plan the optimal pruning path.

Each embodiment in this specification is described in a progressive manner, with each embodiment focusing on the differences from other embodiments, and the same or similar parts between various embodiments may be cross-referenced. For device embodiments, since they basically correspond to method embodiments, the descriptions are relatively simple, and relevant aspects may be referred to in the partial descriptions of the method embodiments.

FIG. 18 is a structural schematic diagram of a device for assisting users in plant cultivation according to some embodiments of the present disclosure.

As shown in FIG. 18, the device 1800 for assisting the user in plant cultivation includes a determining module 1810 and a depicting module 1820.

The determining module 1810 is configured to determine a pruning plan according to the plant species and pruning goal, and determine whether to display the pruning plan to the user according to the season and the plant growth stage, wherein the pruning plan includes the pruning approach and pruning position.

The depicting module 1820 is configured to, in response to determining to display the pruning plan to the user, depict the pruning approach and pruning position in combination with the image of the plant to display the pruning plan to the user.

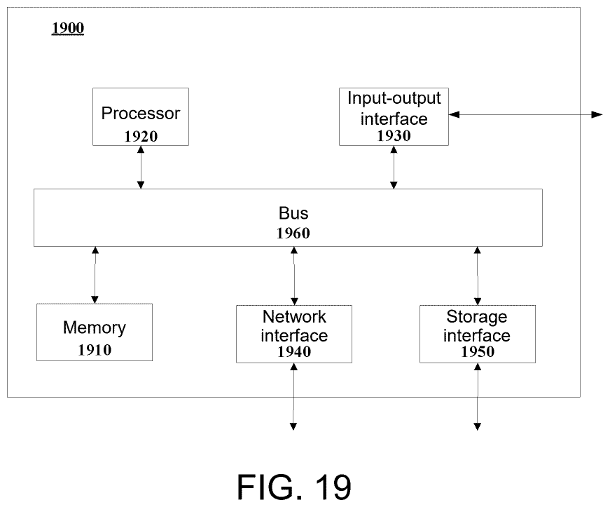

FIG. 19 is a structural schematic diagram of a device for assisting users in plant cultivation according to some embodiments of the present disclosure.

As shown in FIG. 19, the device 1900 for assisting the user in plant cultivation includes a memory 1910 and a processor 1920 coupled to the memory 1910, wherein the processor 1920 is configured to execute the method described in any one of the aforementioned embodiments based on instructions stored in the memory 1910.

The memory 1910 may include, for example, a system memory, a fixed non-volatile storage media, etc. The system memory may store operating systems, applications, Boot Loader, and other programs, etc.

The device 1900 for assisting the user in plant cultivation may also include an input-output interface 1930, a network interface 1940, a storage interface 1950, etc. These interfaces 1930, 1940, 1950, as well as the memory 1910 and the processor 1920, may be connected through a bus 1960. The input-output interface 1930 provides connection interfaces for a display, a mouse, a keyboard, a touch screen, and other input-output devices. The network interface 1940 provides connection interfaces for various networking devices. The storage interface 1950 provides connection interfaces for external storage devices such as SD cards, USB drives, etc.

The embodiments of the present disclosure also provide a non-transitory computer-readable storage medium, including computer program instructions, wherein when the computer program instructions are executed by a processor, the method described in any one of the above embodiments is implemented.

The embodiments of the present disclosure further provide a computer program product, including a computer program, wherein when the computer program is executed by a processor, the method described in any one of the above embodiments is implemented.

At this point, the various embodiments of the present disclosure have been described in detail. To avoid obscuring the concept of the present disclosure, some details commonly known in the art have not been described. Based on the above description, those skilled in the art can fully understand how to implement the technical solutions disclosed herein.

Those skilled in the art should understand that the embodiments of the present disclosure may be provided as a method, system, or computer program product. Therefore, the present disclosure may take the form of an entirely hardware embodiment, an entirely software embodiment, or an embodiment combining software and hardware aspects. Moreover, the present disclosure may take the form of a computer program product implemented on one or more computer-usable non-transitory storage media (including but not limited to magnetic disk storage, CD-ROM, optical storage, etc.) containing computer-usable program code.

The present disclosure is described with reference to flowcharts and/or block diagrams of methods, devices (systems), and computer program products according to embodiments of the present disclosure. It should be understood that the functions specified in one or more processes in the flowcharts and/or one or more blocks in the block diagrams may be implemented by computer program instructions. These computer program instructions may be provided to a processor of a general-purpose computer, a special-purpose computer, an embedded processor, or other programmable data processing device to produce a machine, such that the instructions executed by the processor of the computer or other programmable data processing device create a device for implementing the functions specified in one or more processes in the flowcharts and/or one or more blocks in the block diagrams.

These computer program instructions may also be stored in a computer-readable memory that can direct a computer or other programmable data processing device to work in a specific approach, such that the instructions stored in the computer-readable memory produce a manufactured product including an instruction device. The instruction device implements the functions specified in one or more processes in the flowcharts and/or one or more blocks in the block diagrams.

These computer program instructions may also be loaded onto a computer or other programmable data processing device, such that a series of operational steps are performed on the computer or other programmable device to produce a computer-implemented process, thereby the instructions executed on the computer or other programmable device provide steps for implementing the functions specified in one or more processes in the flowcharts and/or one or more blocks in the block diagrams.

Although some specific embodiments of the present disclosure have been described in detail through examples, those skilled in the art should understand that the above examples are only for illustration and not for limiting the scope of the present disclosure. Those skilled in the art should understand that modifications may be made to the above embodiments or equivalent substitutions may be made to some technical features without departing from the scope and spirit of the present disclosure. The scope of the present disclosure is limited by the appended claims.

What is claimed is:

1. A method for assisting a user in plant cultivation, comprising:
determining a pruning plan according to a plant species and a pruning goal, and determining whether to display the pruning plan to the user according to a current season and/or a plant growth stage, wherein the pruning plan comprises a pruning approach and a pruning position; and
in response to determining to display the pruning plan to the user, depicting the pruning approach and the pruning position in combination with an image of a plant to display the pruning plan to the user.

2. The method according to claim 1, wherein
the pruning goal comprises one or more of maintaining aesthetics, maintaining health, treating pests and diseases, facilitating flowering, and facilitating fruiting;
the pruning approach comprises one or more of pruning tools, a pruning method, and a pruning degree, wherein, the pruning tools comprises one or more of non-gardening scissors, pruning shears, hedge shears, a pruning saw, and a lawn mower;
the pruning method comprises one or more of pruning broken branches, pruning dead branches, pruning weak branches, pruning diseased branches, pruning tillering branches, pruning drooping branches, pruning parallel branches, pruning crossing branches, pruning retrograde branches, pruning withered flowers, pruning new branches, pruning old branches, pinching, fruit thinning, and bud thinning;
the pruning degree indicates an amount to be pruned.

3. The method according to claim 1, further comprising:
before determining whether to display the pruning plan to the user according to the current season and/or the plant growth stage, determining the current season according to time information, geographical location information, and climate information,
wherein the plant growth stage comprises a growth period, a dormant period, a flowering period, and a fruiting period.

4. The method according to claim 1, further comprising determining the pruning plan according to the plant species, the pruning goal, and other factors, wherein,
the other factors comprise one or more of a plant health status, a plant growth speed, plant growth years, plant ecological features, plant ornamental properties, a plant growth space, a plant size, a plant age, plant morphological features, and user factors;
the plant growth years comprise annual and perennial varieties; the plant ecological features comprise one or more of evergreen plants, deciduous plants, flowering plants, non-flowering plants, fruit plants, and non-fruit plants, wherein, flowering plants comprise new branch/old branch flowering, and fruit plants comprise new branch/old branch fruiting; the plant ornamental properties comprise flowering/non-flowering properties; the plant growth space comprises indoor space and outdoor space; the plant morphological features comprise one or more of single head, multiple heads, broken branches, dead branches, weak branches, diseased branches, tillering branches, drooping branches, parallel branches, crossing branches, and retrograde branches.

5. The method according to claim 1, further comprising: before determining the pruning plan according to the plant species and the pruning goal,
directly obtaining the plant species from the user through a human-computer interaction approach; and/or
obtaining the plant species from the image provided by the user through a computer vision technology.

6. The method according to claim 5, wherein in situation where the plant species is obtained from the image provided by the user through at least the computer vision technology,
depicting the pruning position in combination with the image of the plant comprises marking the pruning position on the image provided by the user.

7. The method according to claim 1, wherein determining the pruning plan according to the plant species and the pruning goal comprises:
utilizing a pre-trained pruning recognition model to determine the pruning plan according to the plant species and the pruning goal.

8. The method according to claim 1, wherein
the pruning plan further comprises one or more of pruning precautions, pruning principles, pruning theories, and pruning effects, wherein, the pruning principles comprise hard pruning and light pruning.

9. The method according to claim 1, further comprising:
determining a pruning plan according to a plant species and the plant growth stage, wherein the pruning plan comprises a description of the pruning approach and a pruning time, as well as a marking of the pruning position, wherein the pruning time comprises a pruning season; and
in response to a current time matching the pruning time, displaying the pruning plan to the user.

10. The method according to claim 1, further comprising:
determining a plurality of pruning topics according to the plant species, the current season, the plant growth stage and the pruning goal;
displaying the plurality of pruning topics to the user;
in response to a user's selection operation on the plurality of pruning topics, determining a pruning plan related to the pruning topic selected by the user; and
displaying the pruning plan to the user.

11. The method according to claim 1, further comprising:
providing a cultivation details page for a specific plant species, the cultivation details page comprises operable items related to plant pruning goals, the plant pruning goals comprise one or more of maintaining aesthetics, maintaining health, treating pests and diseases, facilitating flowering and facilitating fruiting; and
in response to the operable items related to the plant pruning goals being operated, displaying a pruning plan corresponding to a selected pruning goal to the user in combination with a plant image of the specific plant species,
wherein, the pruning plan is determined at least based on the specific plant species and the pruning goal, which is selected.

12. The method according to claim 11, further comprising:
in response to the selected pruning goal comprising maintaining aesthetics, providing a plurality of pruning topics;
in response to at least one pruning topic among the plurality of pruning topics being selected, displaying a pruning plan corresponding to a selected pruning topic to the user.

13. The method according to claim 11, wherein
under the corresponding pruning goal, the pruning plan comprises a pruning time, the pruning position, a pruning tool, a pruning method and a pruning degree of the specific plant species.

14. The method according to claim 1, further comprising:
recognizing plant properties and a plant status according to at least one of images of the plant;
determining whether the plant needs to be pruned according to the plant properties and the plant status; and
in response to the plant needing to be pruned, outputting a prompt indicating that the plant needs to be pruned to the user.

15. The method according to claim 14, further comprising:
determining whether the plant needs to be pruned according to the plant properties and the plant status, as well as various pruning goals;
in response to the plant needing to be pruned under any of the pruning goals, determining that the plant needs to be pruned,
wherein, the pruning goals comprise maintaining aesthetics, maintaining health, treating pests and diseases, facilitating flowering and facilitating fruiting.

16. The method according to claim 15, further comprising:
in response to the plant needing to be pruned, determining a pruning plan according to the plant properties, the plant status, and the corresponding pruning goal, the pruning plan comprises a pruning approach and the pruning position; and
depicting the pruning approach and the pruning position in combination with the one or more images to display the pruning plan to the user.

17. The method according to claim 15, further comprising:
in response to the plant needing to be pruned, determining a pruning time suitable for pruning the plant according to the plant properties, the plant status, and the corresponding pruning goal; and
in response to the pruning time being later than a current time, setting a corresponding reminder according to the pruning time.

18. The method according to claim 14, wherein
the plant properties comprise a plant species,
the plant status comprises at least one of a plant growth stage, a plant health condition and plant pests and diseases.

19. A device for assisting a user in plant cultivation, comprising:
a determining module, configured to determine a pruning plan according to a plant species and a pruning goal, and determine whether to display the pruning plan to the user according to a current season and/or a plant growth stage, wherein the pruning plan comprises a pruning approach and a pruning position; and
a depicting module, configured to, in response to determining to display the pruning plan to the user, depict the pruning approach and the pruning position in combination with an image of a plant to display the pruning plan to the user.

20. A system for assisting a user in plant cultivation, comprising:
a pruning device, comprising:
a camera, configured to recognize a position where a plant needs to be pruned;
a plurality of pruning tools,
a processor, configured to control the pruning device to move to the position and to perform pruning using a current pruning tool among the plurality of pruning tools.

21. The system according to claim 20, wherein
the camera recognizes whether the current pruning tool is appropriate, when the camera recognizes that the current pruning tool is inappropriate, the processor controls the pruning device to replace the current pruning tool with another pruning tool among the plurality of pruning tools.

22. The system according to claim 21, wherein
the camera generates a signal to the processor according to the position where the plant needs pruning, and the signal in turn links the processor to control the current pruning tool to move to the position where the plant needs pruning, so as to control the pruning device to execute a pruning operation,
wherein the camera recognizes whether the plant meets a standard after the pruning operation is completed.

23. The system according to claim 20, wherein
the pruning device further comprises:
a multi-segment pruning arm, configured to perform stretchable movement as well as control an angle of each of segments of the pruning arm,
wherein the multi-segment pruning arm performs pruning at different angles according to a pruning operation.

24. The system according to claim 20, further comprising a camera device, wherein the camera device recognizes and captures a plurality of plant images, and transmits the plurality of plant images to the processor,
wherein the processor establishes a model according to the plurality of plant images to plan an optimal pruning path.

25. The system according to claim 20, wherein
the pruning device is a drone device, the camera and plurality of pruning tools are integrated into the drone device, wherein the camera on the drone device is configured to recognize a target plant,
wherein the drone device adjusts its own position to a suitable height for pruning according to recognition results of the target plant, and activates the current pruning tool.

26. The system according to claim 25, further comprising:
a front-end guiding device, which is disposed on the drone device,
wherein the front-end guiding device guides the target plant into a cutting range of the pruning device to execute a pruning operation.

27. The system according to claim 25, further comprising:
an airflow guiding device, which is disposed on the drone device,
wherein the airflow guiding device guides an airflow around the drone device, thereby avoiding an impact of the airflow formed by rotation of flight blades of the drone device on pruning of the target plant,
after a pruning operation is completed, the airflow guiding device blows trimmed branches and leaves to a default position, and collects the trimmed branches and leaves.

28. The system according to claim 25, further comprising:
a pruning waste sweeping device, which is disposed on the drone device,
wherein the pruning waste sweeping device processes trimmed branches and leaves through one of suction and blowing methods to shred the trimmed branches and leaves,
wherein the pruning waste sweeping device performs waste processing on the branches and leaves to convert the branches and leaves into a fertilizer, then, the pruning waste sweeping device performs fertilization processing,
wherein the pruning waste sweeping device moves the branches and leaves to a fixed position.

29. The system according to claim 20, wherein the camera scans the plant to build a model, wherein the model generates a pruning plan according to recognition results of the camera to determine a pruning position and a pruning approach, and the system marks the pruning position on the model to enable the pruning device to perform pruning.

30. The system according to claim 20, wherein when there are a plurality of plants, the processor builds a model based on positions of the plurality of the plants as a whole to plan an optimal pruning path,
wherein the processor transmits the optimal pruning path to the pruning device to enable the pruning device to execute a pruning operation.
